(19) United States
(12) Patent Application Publication
(10) Pub. No.: US 2013/0163912 A1
(43) Pub. Date: Jun. 27, 2013

(54) COLLAPSIBLE TOLERANCE RINGS WITH WEAK POINTS

(71) Applicants: Prapan Aparimarn, Bangkok (TH); Piriyakorn Jirawattanakasem, Samutprakarn (TH); Joompondej Bamrungwongtaree, Bangkok (TH)

(72) Inventors: Prapan Aparimarn, Bangkok (TH); Piriyakorn Jirawattanakasem, Samutprakarn (TH); Joompondej Bamrungwongtaree, Bangkok (TH)

(73) Assignee: SEAGATE TECHNOLOGY LLC, Cupertino, CA (US)

(21) Appl. No.: 13/557,549

(22) Filed: Jul. 25, 2012

(30) Foreign Application Priority Data
Dec. 22, 2011 (US) PCT/US11/66779

(51) Int. Cl. F16C 33/00; B23P 11/02

(52) U.S. Cl. 384/626; 29/446

(57) ABSTRACT

In certain embodiments, a method includes positioning a tolerance ring between a bearing assembly and an actuator arm. The tolerance ring is compressed so that the tolerance ring buckles at predetermined weak points to position the bearing assembly relative to the actuator arm.

In certain embodiments, an assembly includes a tolerance ring buckle-fitted between first and second annular surfaces, the tolerance ring buckled at designated weak points to position the first annular surface to the second annular surface.

### RELATED APPLICATIONS

The present application is related to PCT application Ser. No. PCT/U.S.11/66779 filed on Dec. 22, 2011, entitled “Collapsible tolerance rings with weak points” from which priority is claimed and which application is incorporated by reference herein in its entirety.

### TECHNICAL FIELD

Certain embodiments of the present disclosure are generally directed to methods and devices including collapsible tolerance rings.

### SUMMARY

In certain embodiments, a method includes positioning a tolerance ring between a bearing assembly and an actuator arm. The tolerance ring is compressed so that the tolerance ring buckles at predetermined weak points to position the bearing assembly relative to the actuator arm.

In certain embodiments, an assembly includes a tolerance ring buckle-fitted between first and second annular surfaces, the tolerance ring is buckled at designated weak points to position the first annular surface to the second annular surface.

### BRIEF DESCRIPTION OF THE DRAWINGS

FIG. 1 provides an exploded view of an actuator arm and bearing assembly, in accordance with certain embodiments of the present disclosure.

FIG. 2 provides a perspective view of a tolerance ring, in accordance with certain embodiments of the present disclosure.

FIG. 3A provides a perspective view of a tolerance ring, in accordance with certain embodiments of the present disclosure.

FIG. 3B provides a side view of the tolerance ring of FIG. 3A.

FIG. 4 provides a section view of an actuator arm and bearing assembly, in accordance with certain embodiments of the present disclosure.

FIG. 5 provides a section view of an actuator arm and bearing assembly, in accordance with certain embodiments of the present disclosure.

FIG. 6 provides a perspective view of a tolerance ring, in accordance with certain embodiments of the present disclosure.

FIG. 7 provides a routine illustrative of steps carried out in accordance with certain embodiments of the present disclosure.

### DETAILED DESCRIPTION

The present disclosure relates to devices, systems, and methods including collapsible tolerance rings. Tolerance rings can be utilized, among other applications, in disc drives to couple actuator arms to actuator pivot bearings/assemblies. Further, tolerance rings can prevent slippage between the arm and bearing assembly during operation of disc drives or during shock events.

Some tolerance ring designs and installation methods include rings with protrusions that frictionally engage with an inner surface of an actuator arm. These rings can be installed by first installing the ring into an actuator arm and then forcibly pressing a bearing assembly into the ring—a press fit where an inner diameter of the ring is smaller than an outer diameter of the bearing assembly. Conversely, rings can first be installed around the bearing and then forcibly pressed into the actuator arm—a press fit where an outer diameter of the ring's protrusions is larger than an inner diameter of the actuator arm. Either way, the act of forcibly pressing a component into another component creates particles as surfaces scratch against each other, particularly when a metal surface is involved.

Certain embodiments of the present disclosure are accordingly directed to systems, devices, and methods for reducing particle generation by utilizing collapsible tolerance rings.

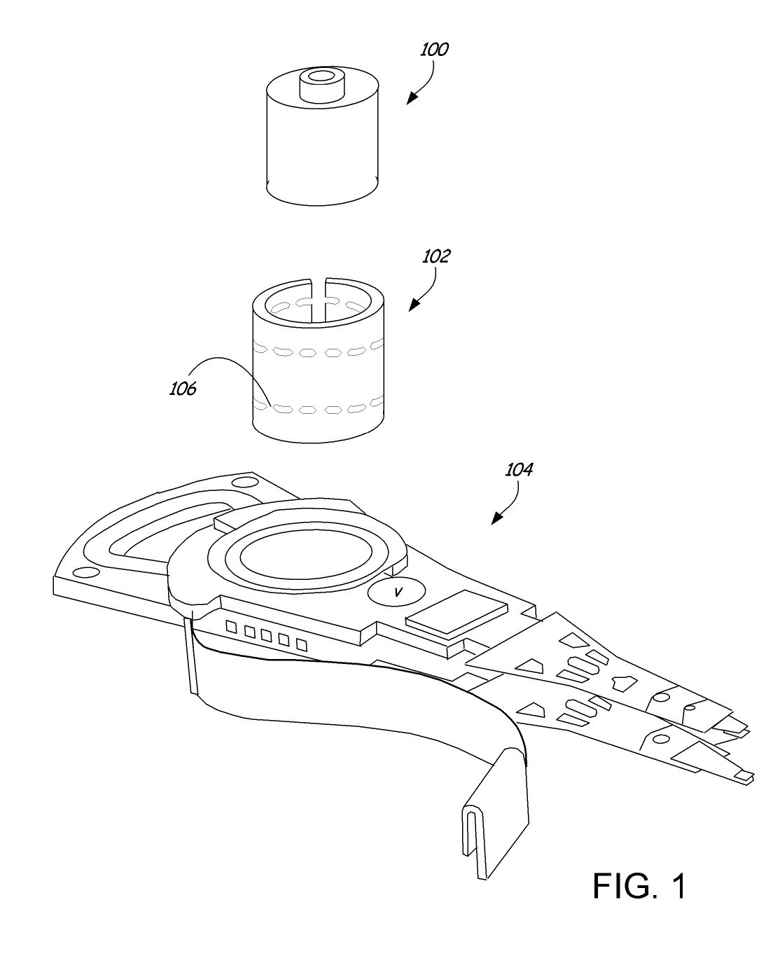

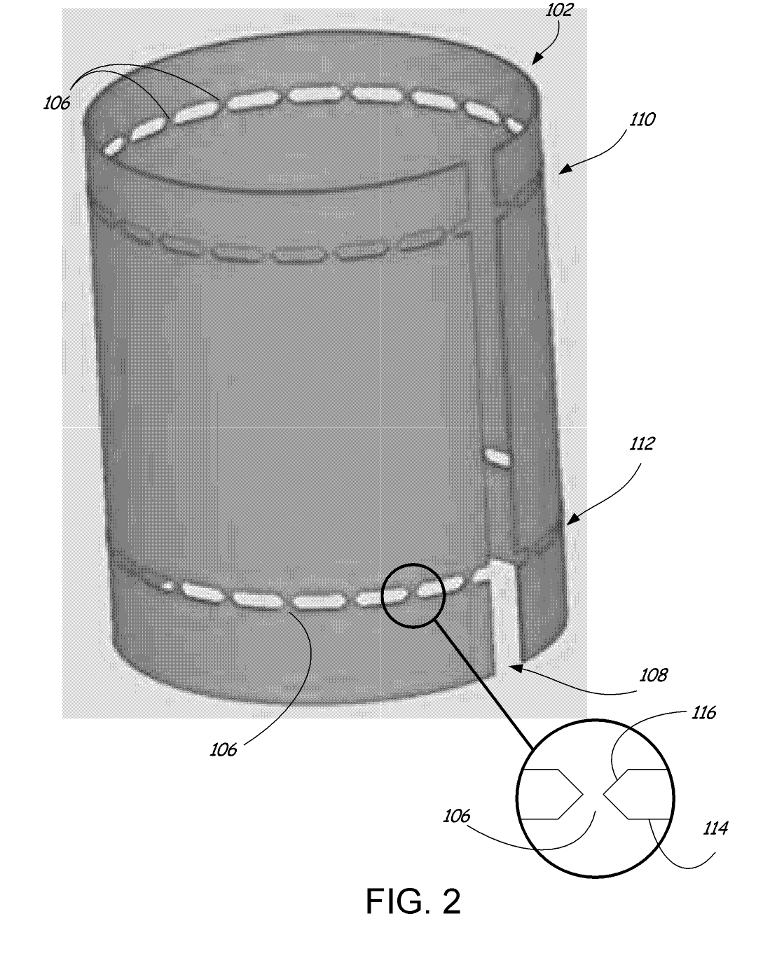

FIG. 1 provides an exploded view of a bearing assembly 100, tolerance ring 102, and actuator arm 104. FIG. 2 provides a closer view of the tolerance ring 102 including weak points 106. The tolerance ring 102 is a strip formed into a cylindrical or annular shape and is shown as having a gap 108 between ends of the strip. The weak points 106 are arranged around the tolerance ring 102 in two rows—an upper row 110 and a lower row 112. The weak points 106 can be uniformly or non-uniformly spaced. As shown in FIG. 2, the weak points 106 can be formed by including slots 114 with triangular ends 116, where a weak point a remaining portion material between and around the slots 114. When formed by slots 114 with triangular ends 116, the weak points 106 take on an hourglass-like shape. However, the weak points 106 can be formed from shapes other than slots and triangles. For example, the weak points 106 can be diamond-shaped, circular, square, among other shapes. The slots 114 can have rounded or square ends, among other shapes. Further, in certain embodiments, slots could be replaced with grooves or other indents on the outer surface of the tolerance ring 102 that do not go completely through a thickness of the tolerance ring 102.

The weak points 106 are designed to buckle or collapse upon an axial load or force being applied to the tolerance ring 102. The weak points 106 can buckle inwards or outwards, depending on the configuration of the tolerance ring 102 and weak points 106. The upper row 110 of weak points 106 can be configured to collapse after the lower row 112 of weak points 106. For example, the lower row 112 can be designed to be weaker than the upper row 110. Doing so allows, during assembly, for a force that is exerted on a top of the tolerance ring 102 to be translated through the upper row 110 of weak points 106 to the lower row 112 to collapse and expand to position the tolerance ring 102 against a bottom portion of a bearing assembly and actuator arm. The upper row 110 of weak points 106 can be collapsed next using a second force to position an upper portion of the bearing assembly and actuator arm. In certain embodiments, the upper and low rows of weak points can have a converse strength relationship or an equal relationship, depending on the desired order of assembly. The tolerance ring 102 can be made from a variety of materials, for example, metals like steel or aluminum, among others.

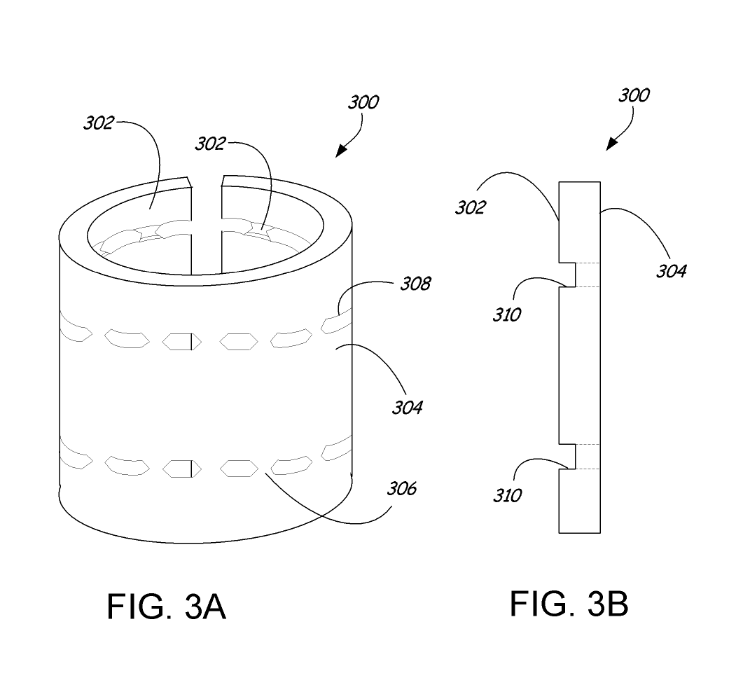

FIG. 3A provides a perspective view of a tolerance ring 300. The tolerance ring 300 has an inner surface 302 and an outer surface 304. The tolerance ring 300 includes weak points 306, shown as a portion of the tolerance ring 300 between slots 308. As shown in FIG. 3B, an indent 310 is formed at the inner surface 302 along the weak points 306 so that a thickness of the tolerance ring 300 is smaller at the weak points 306. The indent 310, in addition to the weak points 306, further reduces the tolerance ring's ability to withstand buckling or collapse under pressure. Indents can be positioned at or around a single row of weak points, or any combination of rows of weak points.

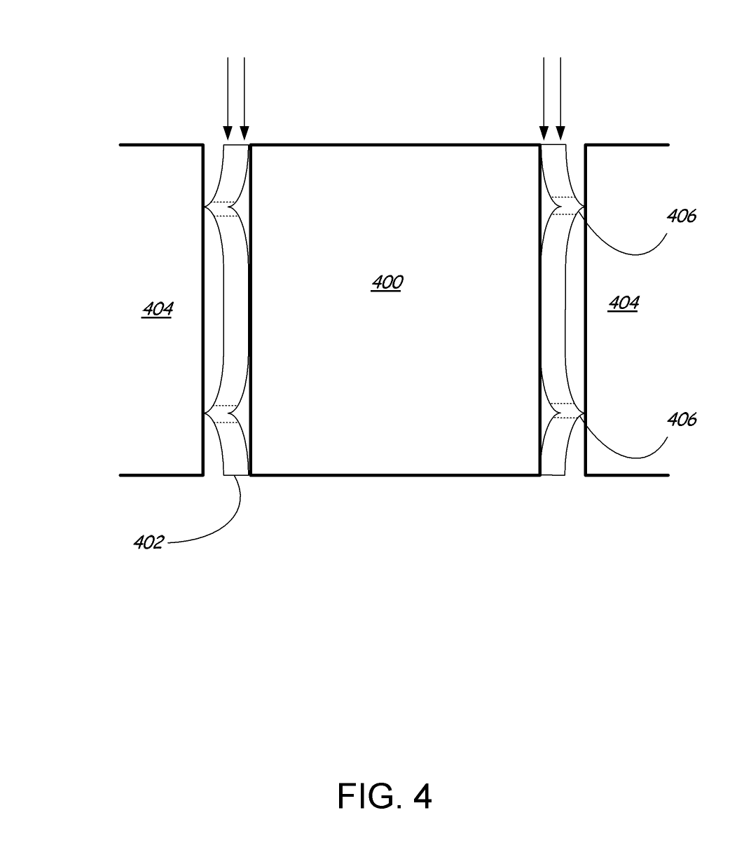

FIG. 4 is a side view of a bearing assembly 400, tolerance ring 402, and a portion of an actuator arm 404. The tolerance ring 402 includes weak points 406 and is buckled-fitted between the bearing assembly 400 and actuator arm 404. The weak points 406 can be arranged around the tolerance ring at multiple rows and can be uniformly spaced. As shown in FIG. 4, the tolerance ring 402 is buckled-out at the weak points 406 such that the tolerance ring's diameter expands to position the bearing assembly 400 relative to the actuator arm 404. For example, the tolerance ring 402 couples the bearing assembly 400 to the actuator arm 404. As shown by arrows pointed toward the top of the tolerance ring 402, an axial force or load is applied to the top of the tolerance ring 402 to cause the tolerance ring 402 to buckle at the weak points 406. The buckling and actual fit of the tolerance ring 402 shown in FIG. 4 is exaggerated so that features and the relationship between the features are clearly shown.

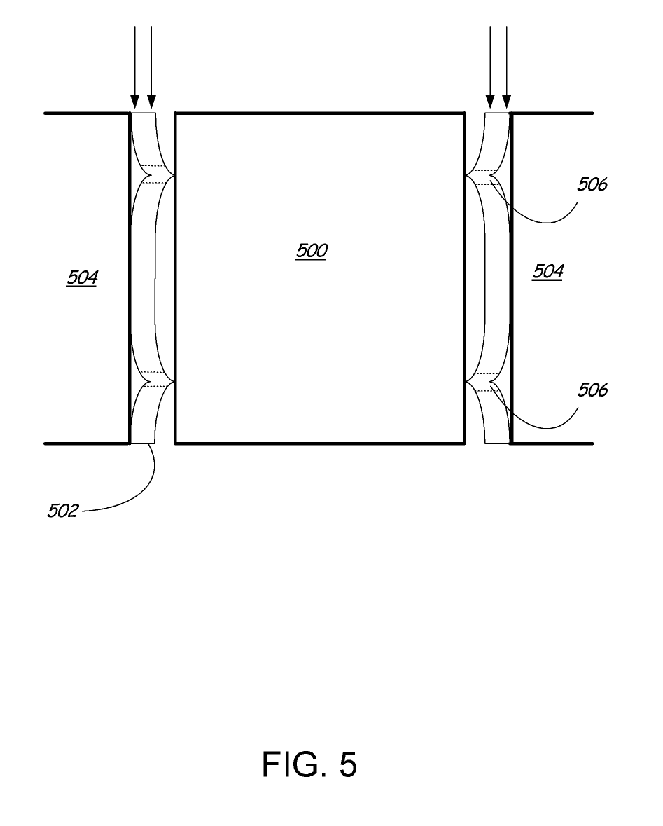

FIG. 5 is a side view of a bearing assembly 500, tolerance ring 502, and a portion of an actuator arm 504. The tolerance ring 502 includes weak points 506 and is buckled-fitted between the bearing assembly 500 and actuator arm 504. The weak points 506 can be arranged around the tolerance ring at multiple rows and can be uniformly spaced. As shown in FIG. 5, the tolerance ring 502 is buckled inwards at the weak points 506. This configuration is reversed from the configuration of FIG. 4. As shown by arrows pointed toward the top of the tolerance ring 502, an axial force or load is applied to the top of the tolerance ring 502 to cause the tolerance ring 502 to buckle inward at the weak points 506. The buckling and actual fit of the tolerance ring 502 shown in FIG. 5 is exaggerated so that features and the relationship between the features are clearly shown.

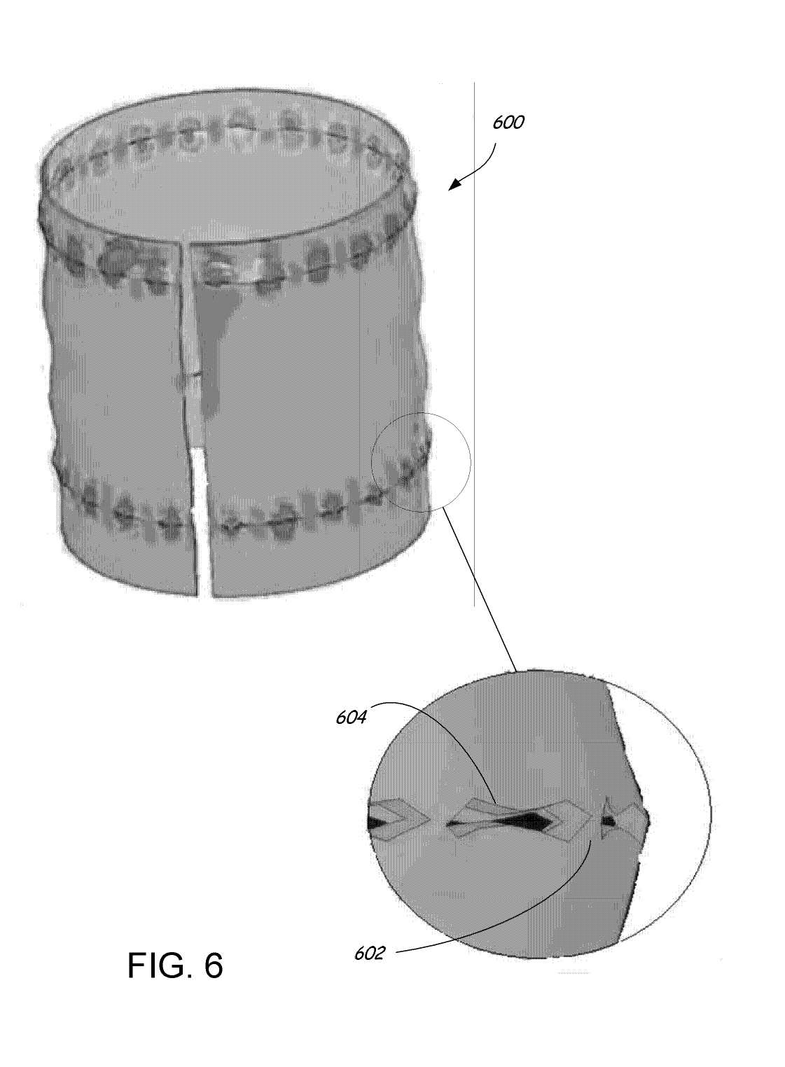

FIG. 6 is a perspective view of a collapsed tolerance ring 600. As shown in a close-up view, when collapsed, the tolerance ring 600 deforms and expands outward. The tolerance ring 600 buckles outward at predetermined or designated weak points 602. The weak points 602 are surrounded by punched-out portions 604 of the tolerance ring 600, thereby reducing the strength of the tolerance ring 600 at and around the weak points 602.

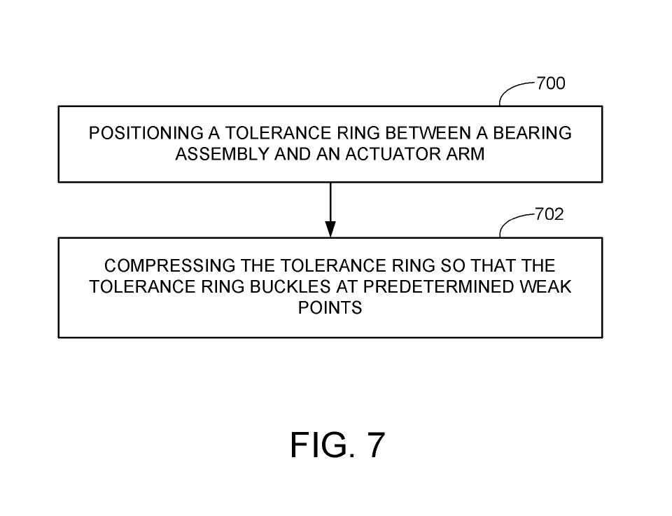

FIG. 7 provides a routine illustrative of steps carried out in accordance with certain embodiments. Step 700 includes positioning a tolerance ring between a bearing assembly and an actuator arm. Step 702 includes compressing the tolerance ring so that the tolerance ring buckles outward at predetermined weak points to position the bearing assembly relative to the actuator arm. An axial load can be used to compress the tolerance ring, resulting in a shortened height of the tolerance ring. The compressing step couples the bearing assembly to the actuator arm. As described above, the tolerance ring can be designed so that a lower row of weak points buckle before an upper row of weak points, or vice versa, depending on an order of assembly.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
positioning a tolerance ring between a bearing assembly and an actuator arm; and
compressing the tolerance ring so that the tolerance ring buckles at predetermined weak points to position the bearing assembly relative to the actuator arm.

2. The method of claim 1, wherein an axial load is used to compress the tolerance ring.

3. The method of claim 1, wherein the compressing step shortens a height of the tolerance ring.

4. The method of claim 1, wherein the weak points buckle inward during the compressing step.

5. The method of claim 1, wherein the weak points buckle outward during the compressing step.

6. The method of claim 1, wherein a lower row of weak points buckle before an upper row of weak points.

7. The method of claim 1, wherein an upper row of weak points buckle before a lower row of weak points.

8. An assembly comprising:
a tolerance ring buckle-fitted between first and second annular surfaces, the tolerance ring buckled at designated weak points to position the first annular surface to the second annular surface.

9. The assembly of claim 8, wherein the weak points are arranged around the tolerance ring.

10. The assembly of claim 9, wherein the weak points are uniformly-spaced around the tolerance ring.

11. The assembly of claim 8, wherein the weak points buckle outward.

12. The assembly of claim 8, wherein the weak points buckle inward.

13. A tolerance ring comprising:
predetermined weak points annularly arranged around the tolerance ring, the weak points configured to buckle upon an applied axial force.

14. The tolerance ring of claim 13, wherein the weak points are partially defined by slots arranged around the tolerance ring.

15. The tolerance ring of claim 13, wherein the weak points are equally-spaced.

16. The tolerance ring of claim 13, further comprising:
an upper row of weak points and a lower row of weak points.

17. The tolerance ring of claim 16, wherein the lower row of weak points are configured to buckle before the upper row of weak points.

18. The tolerance ring of claim 16, wherein an upper row of weak points are configured to buckle before the lower row of weak points.

19. The tolerance ring of claim 13, wherein a thickness of the cylindrical strip is thinner around the weak points than the rest of the strip.

20. The tolerance ring of claim 13, wherein the cylindrical strip defines a plurality of rows of weak points.
